(19) United States
(12) Patent Application Publication
(10) Pub. No.: US 2024/0415716 A1
(43) Pub. Date: Dec. 19, 2024

(54) LOWER LIMB REHABILITATION, MOBILITY AND EXERCISE APPARATUS

(71) Applicants: Alexandra PEREYASLAVETS, Auckland (NZ); Svetlana BRENGAUZ, Hamilton (NZ); Moisey BRENGAUZ, Hamilton (NZ)

(72) Inventors: Alexandra PEREYASLAVETS, Auckland (NZ); Svetlana BRENGAUZ, Hamilton (NZ); Moisey BRENGAUZ, Hamilton (NZ)

(21) Appl. No.: 18/684,722

(22) PCT Filed: Aug. 19, 2022
(86) PCT No.: PCT/NZ2022/050106

§ 371 Date: Feb. 19, 2024

(30) Foreign Application Priority Data
Aug. 19, 2021 (NZ) 779050

(51) Int. Cl. A61H 1/02; A61H 3/04

(52) U.S. Cl. CPC A61H 1/0237; A61H 3/04; A61H 2201/0192; A61H 2201/1276; A61H 2201/14; A61H 2201/1642

(57) ABSTRACT

In one aspect the invention provides a lower limb rehabilitation, mobility and exercise apparatus which includes a chassis having a front end and a rear end, and two foot platforms located between the front and rear ends of the chassis. Also provided is a transfer linkage engaged with each of the two foot platforms, the transfer linkage being connected to the chassis. The apparatus is configured so that motion of one foot platform towards the front end of the chassis causes the transfer linkage to move the remaining foot platform towards the rear end of the chassis.

### FIELD OF THE INVENTION

This invention relates to a lower limb rehabilitation, mobility and exercise apparatus. In various preferred embodiments the invention may allow a user to exercise and/or rehabilitate their lower limbs outside of a hospital or physiotherapy practice setting.

### BACKGROUND OF THE INVENTION

A wide range of injuries and ailments can have an impact on the operation of a person's legs. Physical trauma, strokes and brain injuries, neurological conditions, and cerebral palsy, muscular dystrophy or similar conditions can all have an impact on the functioning of a sufferers lower limbs. Some conditions can also have an asymmetrical effect, leaving one leg stronger or better functioning than it's opposite.

It is important for a person suffering such conditions to maintain or increase their levels of activity and exercise for general health and well-being. Long term rehabilitation focused activities can also improve the functionality of the lower limbs for some conditions.

Hospitals and physiotherapy practices are able to install complex and expensive rehabilitation equipment which allows a range of exercises to be undertaken by those with compromised lower limb function. However is not necessarily appropriate or convenient for all people with such conditions to visit these types of facilities regularly and over long periods of time.

A range of exercise and rehabilitation focused activities can be performed in a home-based setting. However these exercises are generally undertaken from a stationary or seated position and do not effectively emulate or practice actual walking movements.

Walking frame supports have also been developed for use by those with compromised lower limb function, as for example described in US patent U.S. Pat. No. 5,152,730. Although these frames do provide the user with the ability to move themselves they reduce the load applied through the legs and instead transfer this through to the user's upper body and arms. Such walking frames therefore again do not effectively emulate or practice actual walking movements.

It would be of advantage to have improvements in the field of lower limb rehabilitation, mobility and exercise equipment which address the above issues or at least provided an alternative choice over the prior art. An improved lower limb rehabilitation, mobility and exercise apparatus which could be used in an in-home setting and which is small as well as being inexpensive to construct and maintain would also be of advantage.

### DISCLOSURE OF THE INVENTION

According to one aspect of the present invention there is provided a lower limb rehabilitation, mobility and exercise apparatus which includes a chassis having a front end and a rear end, and
two foot platforms located between the front and rear ends of the chassis,
a transfer linkage engaged with each of the two foot platforms, the transfer linkage being connected to the chassis,
wherein motion of one foot platform towards the front end of the chassis causes the transfer linkage to move the remaining foot platform towards the rear end of the chassis.

According to a further aspect of the present invention there is provided a lower limb rehabilitation, mobility and exercise apparatus substantially as described above wherein the transfer linkage includes a main body connected to the chassis and having a longitudinal axis orientated perpendicular to the front end of the chassis, and
at least one turntable engaged with the main body and configured to rotate about an axis perpendicular to the longitudinal axis of the main body,
a plurality of transfer rods, each being connected to one of the two foot platforms and being configured to apply a turning force to the said at least one turntable, the transfer rods being engaged with said at least one turntable so that a force
which moves one foot platform towards the front end of the chassis is transferred through the transfer rods and translated by the turntable to apply a force to the remaining foot platform to move said foot platform towards the rear end of the chassis.

Preferably the transfer linkage is pivotally connected to the front end of the chassis and includes a following roller adjacent to the rear end of the chassis.

Preferably the transfer linkage includes two turntables and each foot platform is connected to two transfer rods which engage the foot platform to the two turntables.

Preferably each of the plurality of transfer rods are configured to slide or telescope in and out of a channel defined by the turntable which the transfer rod is engaged with.

Preferably each transfer rod is connected to a foot platform by being connected to one end of a lifting arm, the opposite end of said lifting arm being connected to a spring-loaded axle housed by the foot platform, whereby depression of the end of the lifting arm connected to the transfer rod loads the spring associated with the axle to apply an upward biasing force to the foot platform.

The present invention provides a lower limb rehabilitation, mobility and exercise apparatus. This apparatus can allow users with compromised balance or lower limb function to execute a walking motion. The invention may be used in a rehabilitation role, or simply to provide a means whereby exercise can be completed.

Reference in general throughout this specification will be made to the invention serving a rehabilitation role for users with compromised lower limb function. In particular the invention may find particular utility with users who have compromised lower limb function on one side of the body and are more capable on the opposite side. In these circumstances the strong limb can assist the weak limb in performing a walking motion.

The invention incorporates a chassis which acts as a support framework for other components of the invention. This chassis can define a front end and a rear end, where the front end generally is orientated towards the direction of travel of a desired walking movement. Preferably the rear end of the chassis may be substantially open, allowing the user to enter into and occupy a space at least partially enclosed by the chassis during use of the apparatus.

The invention also incorporates two foot platforms which are located between the front and rear ends of the chassis. These platforms are employed to locate a user's feet and can be moved relative to the chassis in the execution of a walking motion.

The invention incorporates a transfer linkage which is engaged with each of the two foot platforms and is connected to the chassis. In preferred embodiments this transfer linkage may be provided with a pivoting connection to the front end of the chassis, with the opposite end of the transfer linkage incorporating a following roller. This pivoting connection can provide the transfer linkage with the ability to execute vertical motion relative to the chassis.

The transfer linkage defines main body which is used to locate or house other components of the linkage. The main body defines a longitudinal axis which preferably extends from the front end of the chassis to the rear end of the chassis or adjacent to the rear end of the chassis. This arrangement therefore provides the main body with a longitudinal axis orientated perpendicular to the front end of the chassis.

The main body of the transfer linkage is engaged with and preferably incorporates at least one turntable configured to rotate about an axis perpendicular to the longitudinal axis of the main body. A turntable as used in accordance with the present invention may define a plate or body which rotates around a centralised axis where preferably this plate or body has a circular form. A suitable axle and bearing assembly may also be incorporated into a turntable to reduce friction encountered by the rotation of this plate or body.

In preferred embodiments such a turntable will therefore rotate about a plane which is perpendicular to a surface which the apparatus travels over. In further preferred embodiments a turntable may be housed within a cavity defined within the interior of the main body. In yet further preferred embodiments the transfer linkage may include two turntables located in an array extending along the longitudinal axis of the main body.

The transfer linkage also incorporates a plurality of transfer rods with each rod being connected to one of the two foot platforms and at least the opposite end of the same rod being engaged with a turntable. These rods are used to transfer horizontal motion of a foot platform into rotational motion of the associated turntable. Furthermore a single turntable is preferably associated with the least two transfer rods which act to engage the same turntable with both foot platforms. Rotation of the turntable in one direction will therefore urge one foot platform towards the front end of the chassis, and the opposite foot platform towards the rear end of the chassis.

In preferred embodiments at least one end of each transfer rod may be located within a channel defined by a turntable. In such embodiments the transfer rod may be allowed to slide within this channel to accommodate horizontal motion of a connected foot platform while also applying a torque to the turntable under the action of this horizontal motion.

In various embodiments the apparatus provided may also be configured to simulate a degree of vertical motion in the execution of a walking motion by user.

For example in some embodiments the ends of the transfer rods connected to a foot platform may be engaged with one end of a lifting arm, with the opposite end of this lifting arm being connected to a spring-loaded axle housed within the foot platform. These connections provide a pivot arrangement between the transfer rod and the foot platform. The spring used in this embodiment can be housed inside the platform and engaged with both the axle and connected lifting arm, and also preferably an interior surface of the foot platform. Therefore rotation of the axle will load the spring to apply a biasing force seeking to rotate the axle in the opposite direction which will urge the foot platform upwards. In various preferred embodiments the end of the lifting arm engaged with the transfer rod may also have a wheel or roller mounted to it which contacts the surface over which the apparatus is to move.

This facility of the invention therefore loads the spring associated with this axle when a user places their weight on a foot platform, with the foot platform being depressed downwards as the spring associated with the axle is loaded. As the user acts to lift their foot they will be assisted by the force applied by the spring which will urge the foot platform and the user's foot upwards.

In preferred embodiments the chassis provided with the apparatus may also include at least one vertical upright connected to a handle to allow a user to support themselves using their upper body. In various embodiments the invention may allow the user to move the chassis ahead one step length using a weak limb with the assistance of the transfer linkage and while using the handle referenced above to support their weight. Furthermore a relatively strong limb of user will remain stationary and can again be used to support the weight of the user as their weak limb moves the chassis forward and is exercised.

The present invention may provide many potential advantages over the prior art. In various embodiments the invention may be used in an in-home setting, therefore avoiding the need for a user to travel to a hospital or physiotherapy practice environment. The invention may be constructed with a compact, small design as well as being inexpensive to construct. The invention may allow effective lower limb rehabilitation exercises to be completed, particularly with users which have one
lower limb which is stronger than it's opposite, allowing the strong limb to assist the weak limb in the performance of walking based movements.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 illustrates a partial cross section plan view of a lower limb rehabilitation, mobility and exercise apparatus as provided in accordance with a preferred embodiment of the invention,

FIG. 2 illustrates a view of the apparatus of FIG. 1 as identified by reference arrow A shown with respect to FIG. 1,

FIG. 3 illustrates a view of the apparatus of FIG. 1 as identified by reference arrows B shown with respect to FIG. 2,

FIG. 4 illustrates a view of the apparatus of FIG. 1 as identified by reference arrows C shown with respect to FIG. 2,

FIG. 5 illustrates a cross section view of the apparatus of FIG. 1 as identified by reference arrows D,

FIG. 6 illustrates a side view of apparatus shown with respect to FIGS. 1 to 5,

FIGS. 7a and 8a show side and perspective cross section views of elements of a lower limb rehabilitation, mobility and exercise apparatus as provided in accordance with a further embodiment with a left foot platform positioned to the front of a chassis and a right foot platform positioned to rear of the chassis,

FIGS. 7b and 8b show side and perspective views of the embodiments shown in FIGS. 7a, 8b with the left and right foot platforms passing each other in the centre of the chassis,

FIGS. 7c and 8c show side and perspective views of the embodiments shown in FIGS. 7a, 8b with the left foot platform transitioning to the rear of the chassis and the right foot platform transitioning to the front of the chassis, and

FIGS. 7d and 8d show side and perspective views of the embodiments shown in FIGS. 7a, 8b with the left foot platform positioned to the rear of the chassis and the right foot platform positioned to front of the chassis.

Further aspects of the invention will become apparent from the following description of the invention which is given by way of example only of particular embodiments.

### BEST MODES FOR CARRYING OUT THE INVENTION

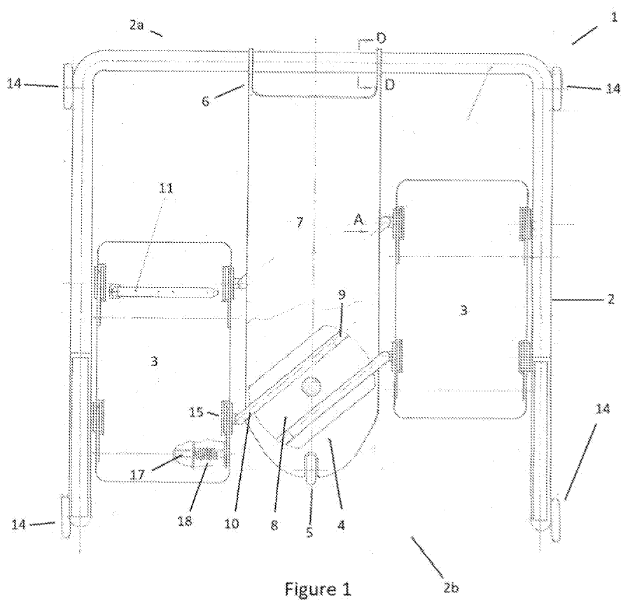

FIGS. 1 through 6 show a number of views of a lower limb rehabilitation, mobility and exercise apparatus 1 as provided in accordance with a preferred embodiment of the invention.

This apparatus includes a chassis 2 having a front end 2a and a rear end 2b. Two foot platforms 3 are located between the front and rear ends of the chassis with a user standing on these platforms between the front and rear ends of the chassis when the invention is used.

A transfer linkage 4 is engaged with each of the two foot platforms 3, and this transfer linkage is connected to the front end 2a of the chassis. In the embodiment shown the transfer linkage 4 includes a following roller 5 adjacent to the rear end of the chassis.

The cross section view of FIG. 5 shows in further detail the connection made between the front end of the chassis 2a and the transfer linkage. In the embodiment shown this connection is made through the use of a swivel hinge 6 which allows a degree of vertical movement of the transfer linkage relative to the chassis.

The transfer linkage incorporates a main body 7 which has a longitudinal axis orientated perpendicular to the front end 2a of the chassis.

The partial cross section view provided by FIG. 1 also illustrates the provision of two turntables 8 housed with the main body 7. These turntables are arranged to rotate about an axis perpendicular to the longitudinal axis of the main body.

Each turntable 8 defines a pair of channels 9 used to receive one of two transfer rods 10 engaged with the turntable. The transfer rods are configured to slide or telescope in and out of their respective channel during use of the apparatus 1.

As can be seen from FIG. 1 the free ends of each transfer rod 10 are engaged with one of the two foot platforms 3. Each foot platform therefore has two transfer rods connected to it, with each of these rods residing in a channel formed in a different turntable 8. These transfer rods are used to apply a turning force to each respective turntable 8 when the apparatus is employed by a user to undertake a walking motion. The user places their feet on the foot platforms 3, and optionally uses a locking belt 11 to hold their feet in place. The rearward foot platform is urged forwards by the user, with the associated transfer rods applying a torque to the turntable which is transferred through to the second transfer rod accommodated by the same turntable. The opposite forward positioned foot platform is therefore simultaneously urged towards the rear end of the chassis as the turntables rotate.

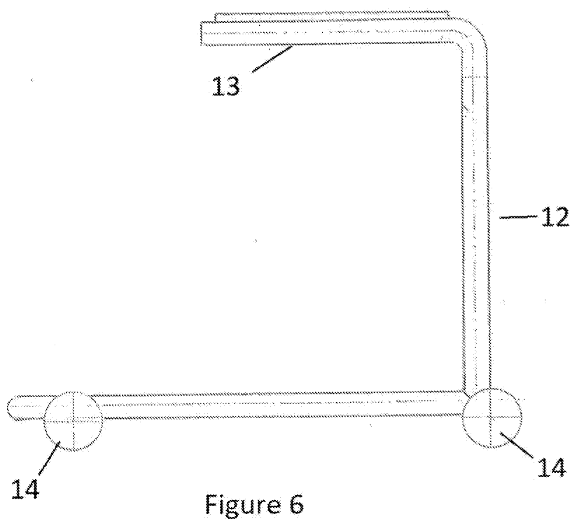

FIG. 6 illustrates a side view of apparatus provided in the embodiment discussed. As can be seen from this view the chassis 2 also defines a vertical upright 12 from which one of a pair of handles 13 extend. During execution of a walking motion a user may also grasp these handles to improve their balance and limit the load they place on each foot platform. Both FIGS. 1 and 6 also illustrate the provision of chassis rollers 14 which assist a user rolling the apparatus forward as they execute a walking motion.

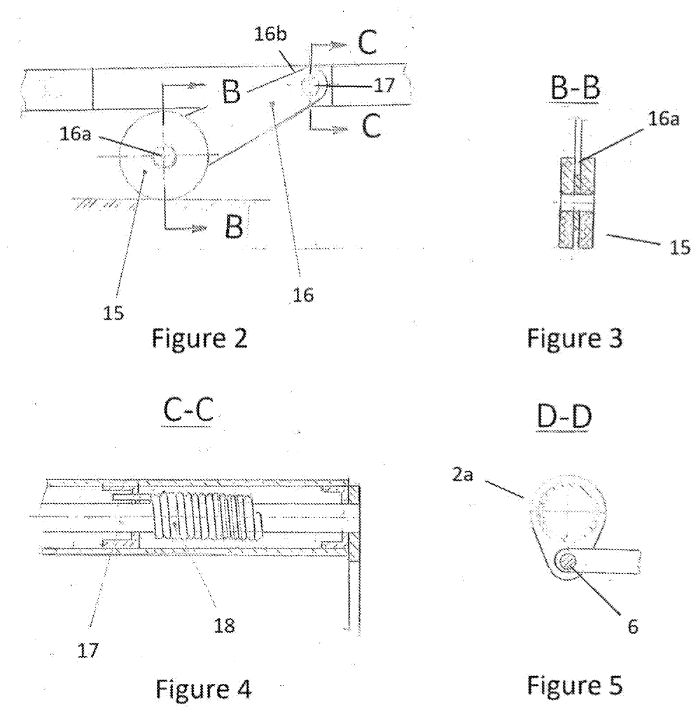

FIGS. 2, 3 and 4 shown more detail how each transfer rod is connected to a foot platform, and how vertical motion is induced into each foot platform during use of the invention. As can be seen from FIG. 2 each transfer rod 10 is connected to a foot platform 3 through a connection to a wheel mounted on one end 16a of a lifting arm 16, where the opposite end 16b of said lifting arm is connected to a spring-loaded axle 17 housed by the foot platform. The axle 17 has a spring 18 connected to it, with an end of this spring being engaged with the interior of the foot platform as illustrated by FIG. 2.

In use this arrangement ensures that depression of the foot platform 3 loads the spring 18 associated with the axle 17 to apply an upward biasing force to the foot platform 3. A user applying their weight to the foot platform will urge the platform downwards, loading the spring while simulating a walking motion. As the user lifts their weight from the walking platform the spring will then urge the walking platform upwards again.

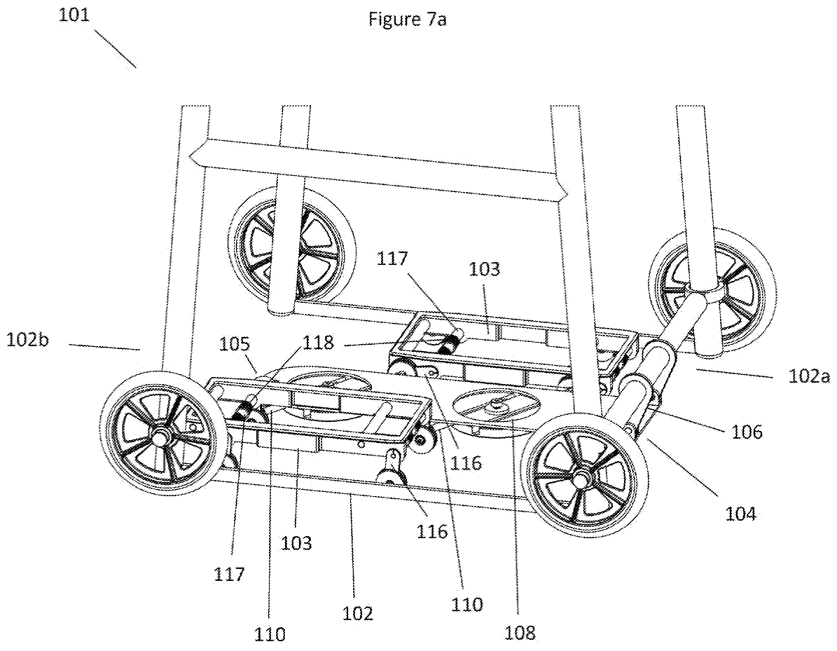

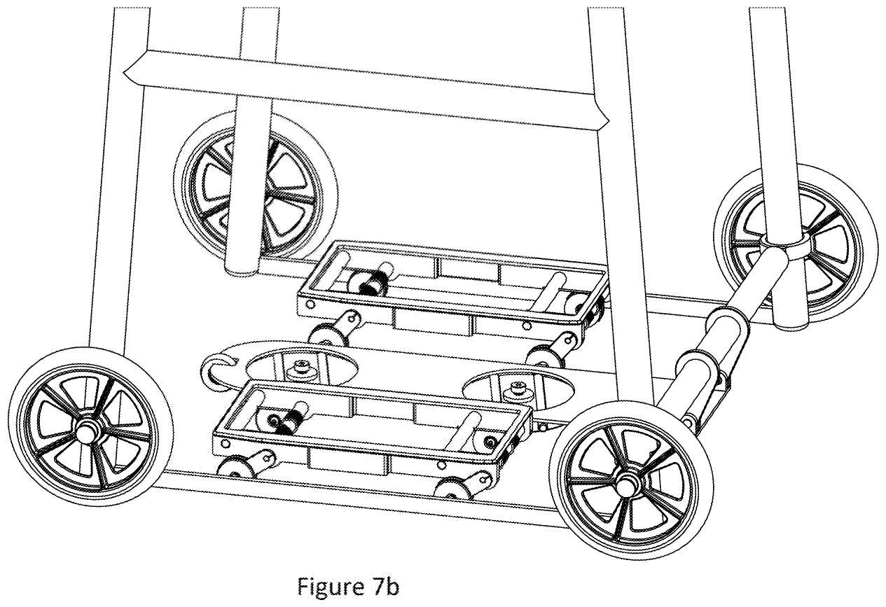

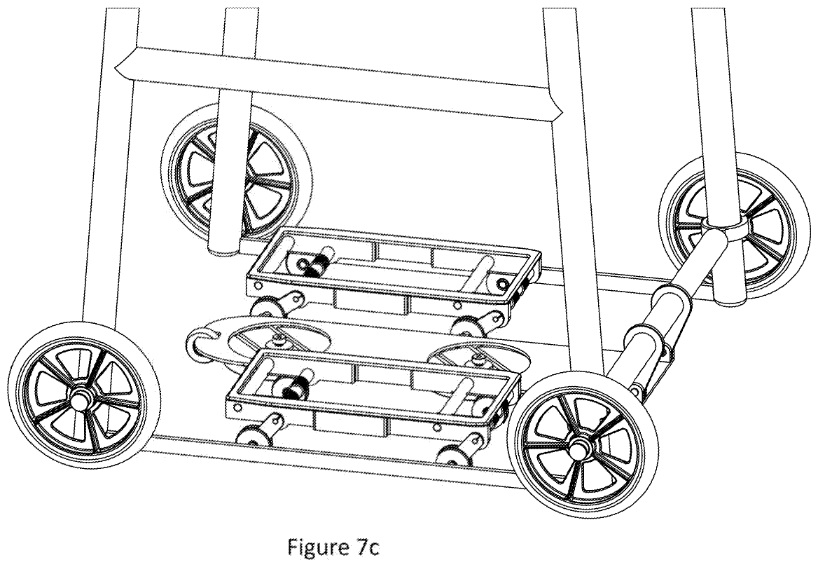

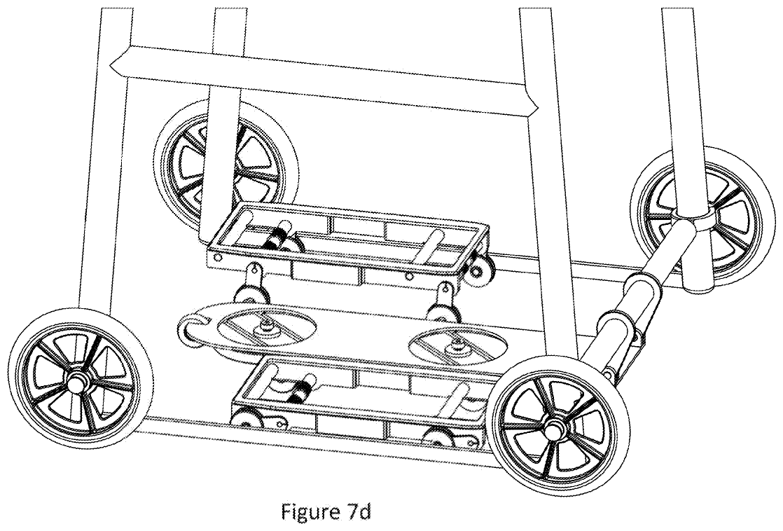

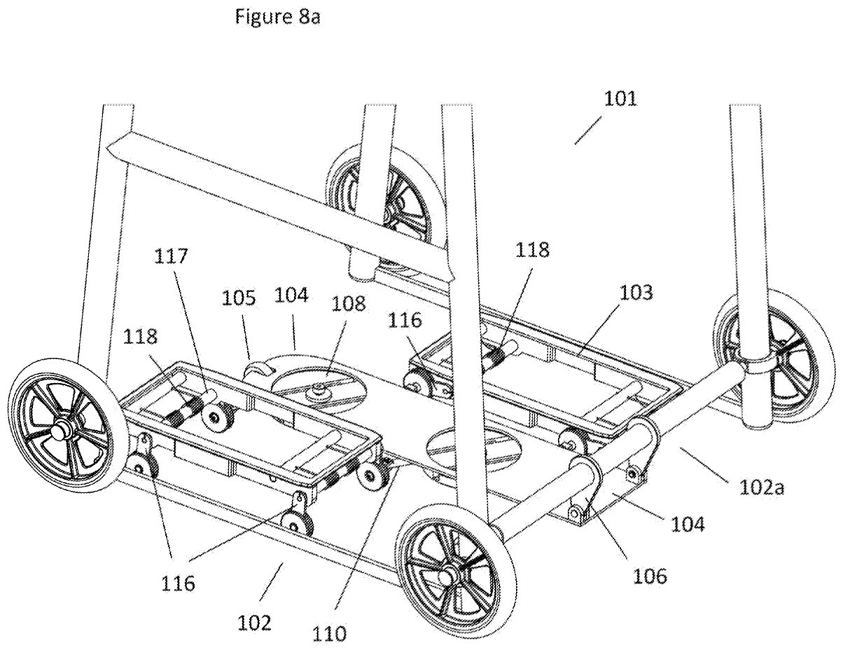

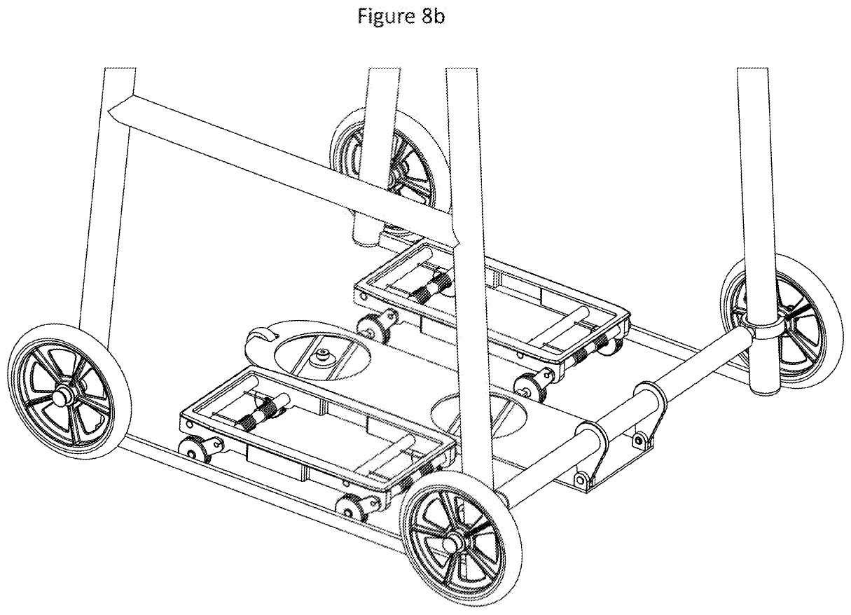

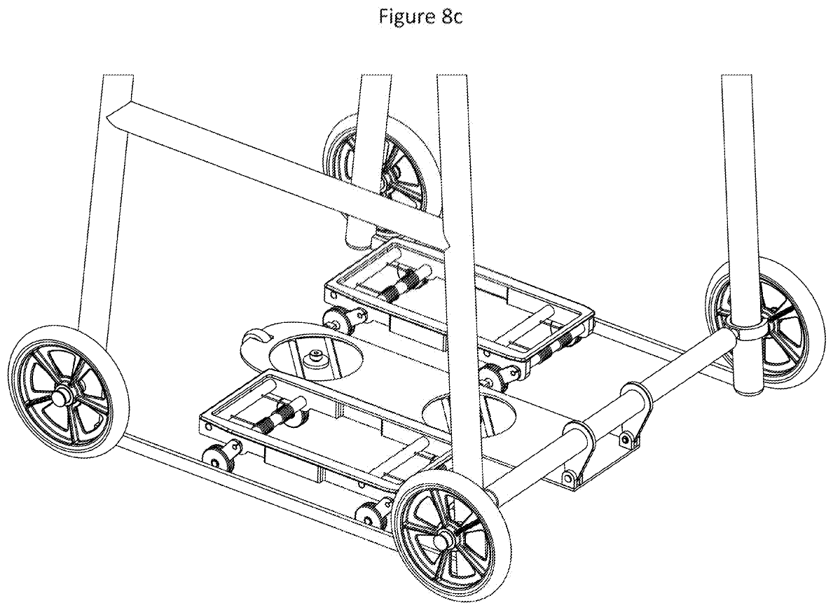

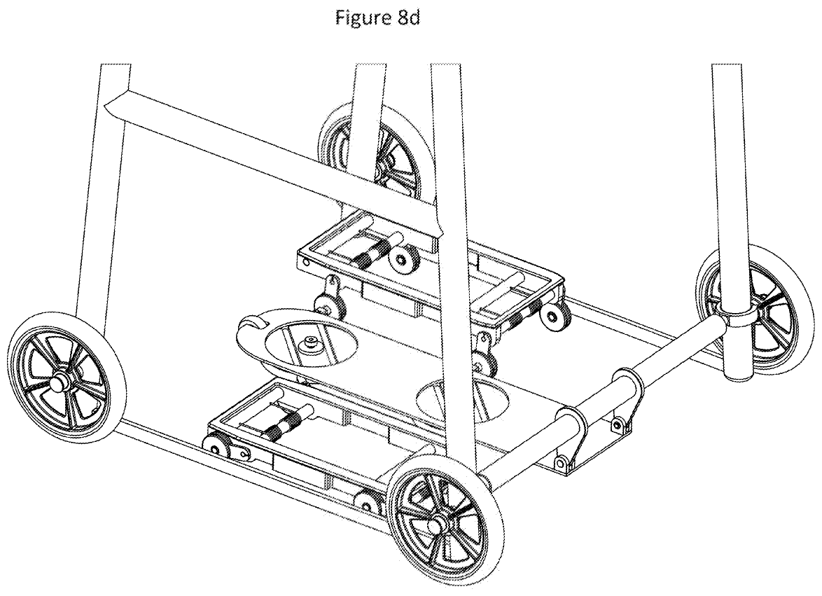

FIGS. 7a and 8a show side and perspective cross section views of elements of a lower limb rehabilitation, mobility and exercise apparatus 101 as provided in accordance with a further embodiment. As with the embodiments shown with respect to FIGS. 1 to 6 the apparatus 101 also includes a chassis 102 with a front end 102a and rear end 102b, in addition to a transfer linkage 104 and following roller 105 connected to the front end 102a of the chassis using a swivel hinge 106.

A pair of foot platforms 103 are provided inside the chassis where in FIGS. 7a, 8a a left foot platform is positioned to the front of a chassis and a right foot platform is positioned to rear of the chassis. Cross section views of each foot platform 103 are also shown, illustrating the provision a set of wheels mounted to lifting arms 116 which are in turn connected to spring loaded axles 117 housed within each foot platform. The wheel end of each lifting arm adjacent to the transfer linkage 104 is connected to one end of a transfer rod 110 extending from a channel defined in a turntable 108 of the transfer linkage 104.

Subsequent FIGS. 7b through 7d and FIGS. 8b through 8d show the operation and motion of these components in the embodiment shown as a user takes a step moving their right foot forward.

As can be seen from FIGS. 7a, 8a the lifting arms of the left foot platform have a horizontal orientation while those of the right foot platform are vertically orientated. From FIGS. 7b, 8b it can be seen that the right foot platform lifting arms are starting to be depressed downwards as the platform moves forwards, rotating the spring-loaded axles 117 and tensioning the spring 118 connected to the foot platform. The right foot platform's connections to the transfer rods 110 of the transfer linkage 104 turntables 108 are also applying force to the adjacent lifting arms and spring-loaded axles of the left foot platform 103 to move the left foot platform backwards relative to the right foot platform. At the same time a tensioning force which has previously loaded the spring 118 of the left foot platform is released to lift the left foot platform upwards as a user shifts their weight off their left foot to take a step with their right foot.

FIGS. 7c, 8c show the continuation of the step motion as the left foot platform continues to rise while receding and the right foot moves downwards and forwards. As these motions occur the turntables continue to transfer a turning force between the adjacent foot platforms while the lifting tension in the spring of the left hand foot platform is released and the spring of the right hand foot flat platform is loaded.

FIGS. 7d, 8d show the completion of the step motion with the lifting arms of the left foot platform having a vertical orientation, and this platform is lifted upwards and the tension in its spring has been released. The right foot platform is advanced in front of the left foot platform with its lifting arms having a horizontal orientation with its internal spring being tensioned

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

What we claim is:

1. A lower limb rehabilitation, mobility and exercise apparatus which includes a chassis having a front end and a rear end, and
two foot platforms located between the front and rear ends of the chassis, a transfer linkage engaged with each of the two foot platforms, the transfer linkage being connected to the chassis,
wherein motion of one foot platform towards the front end of the chassis causes the transfer linkage to move the remaining foot platform towards the rear end of the chassis.

2. A lower limb rehabilitation, mobility and exercise apparatus as claimed in claim 1 wherein the chassis includes at least one vertical upright connected to a handle.

3. A lower limb rehabilitation, mobility and exercise apparatus as claimed in claim 1 or claim 2 wherein the transfer linkage is pivotally connected to the front end of the chassis and includes a following roller adjacent to the rear end of the chassis.

4. A lower limb rehabilitation, mobility and exercise apparatus as claimed in any one of claims 1 to 3 wherein the rear end of the chassis is open allowing a user to enter into and occupy a space at least partially enclosed by the chassis.

5. A lower limb rehabilitation, mobility and exercise apparatus as claimed in any one of claims 1 to 4 wherein the transfer linkage includes a main body which is used to locate or house other components of the linkage, the main body defining a longitudinal axis which extends from the front end of the chassis to the rear end of the chassis.

6. A lower limb rehabilitation, mobility and exercise apparatus as claimed in any one of claims 1 to 5 wherein the main body of the transfer linkage incorporates at least one turntable configured to rotate about an axis perpendicular to the longitudinal axis of the main body.

7. A lower limb rehabilitation, mobility and exercise apparatus as claimed in claim 6 wherein the at least one turntable defines a circular plate which rotates around a centralised axis.

8. A lower limb rehabilitation, mobility and exercise apparatus as claimed in claim 6 or claim 7 wherein the at least one turntable includes an axle and bearing assembly.

9. A lower limb rehabilitation, mobility and exercise apparatus as claimed in any one of claims 6 to 8 wherein the transfer linkage includes two turntables located in an array extending along the longitudinal axis of the main body.

10. A lower limb rehabilitation, mobility and exercise apparatus as claimed in any one of claims 6 to 9 wherein the transfer linkage incorporates a plurality of transfer rods with each rod being connected to one of the two foot platforms the opposite end of the same rod being engaged with a turntable.

11. A lower limb rehabilitation, mobility and exercise apparatus as claimed in claim 10 wherein a single turntable is connected to least two transfer rods which engage the turntable with both foot platforms so that rotation of the turntable in one direction urges one foot platform towards the front end of the chassis and the opposite foot platform towards the rear end of the chassis.

12. A lower limb rehabilitation, mobility and exercise apparatus as claimed in claim 10 or claim 11 wherein at least one end of each transfer rod is located within a channel defined by the rotating plate or body of a turntable.

13. A lower limb rehabilitation, mobility and exercise apparatus as claimed in claim 12 wherein at one of the transfer rods are configured to slide within the channel defined by the turntable.

14. A lower limb rehabilitation, mobility and exercise apparatus as claimed in claim 12 wherein at one of the transfer rods are configured to telescope in and out of the channel defined by the turntable.

15. A lower limb rehabilitation, mobility and exercise apparatus as claimed in any one of claims 6 to 9 wherein the ends of the transfer rods connected to a foot platform are engaged with one end of a lifting arm, with the opposite end of this lifting arm being connected to a spring-loaded axle housed within the foot platform.

16. A lower limb rehabilitation, mobility and exercise apparatus as claimed in claim 15 wherein rotation of the spring-loaded axle loads the spring to apply a biasing force seeking to rotate the axle in the opposite rotational direction.

17. A lower limb rehabilitation, mobility and exercise apparatus as claimed in claim 15 or claim 16 wherein the spring is housed inside the foot platform and engaged with the axle and connected lifting arm.

18. A lower limb rehabilitation, mobility and exercise apparatus as claimed in in any one of claims 15 to 17 wherein the end of the lifting arm engaged with the transfer rod has a wheel mounted to it which contacts the surface over which the apparatus is to move.

19. A lower limb rehabilitation, mobility and exercise apparatus as claimed in claim 1 wherein the transfer linkage includes a main body connected to the chassis and having a longitudinal axis orientated perpendicular to the front end of the chassis, and
at least one turntable engaged with the main body and configured to rotate about an axis perpendicular to the longitudinal axis of the main body,
a plurality of transfer rods, each being connected to one of the two foot platforms and being configured to apply a turning force to the said at least one turntable,
the transfer rods being engaged with said at least one turntable so that a force which moves one foot platform towards the front end of the chassis is transferred through the transfer rods and translated by the turntable to apply a force to the remaining foot platform to move said foot platform towards the rear end of the chassis.
